(19) United States
(12) Patent Application Publication
(10) Pub. No.: US 2002/0158795 A1
(43) Pub. Date: Oct. 31, 2002

(54) ELECTRONIC DISTRESS CALL AND POSITION FINDING SYSTEM FOR RESCUEING DISTRESSED PEOPLE

(76) Inventors: KARL-HEINZ HANSMANN, ROSRATH (DE); CHRISTIANE LINKENBACH, ROSRATH (DE); LUTZ HEINEN, COLOGNE (DE)

Correspondence Address: JACOBSON PRICE HOLMAN & STERN, 400 SEVENTH STREET NW, WASHINGTON, DC, 20004

(21) Appl. No.: 09/403,014

(22) PCT Filed: Jun. 12, 1997
(86) PCT No.: PCT/DE97/01181

(30) Foreign Application Priority Data
Apr. 16, 1997 (DE) 197 15 869.2

(51) Int. Cl. G01S 5/14

(52) U.S. Cl. 342/357.09

(57) ABSTRACT

Electronic distress call and position finding system for rescueing distressed people.

With electronic distress call systems available to date, the receivers cannot find the positions of the distress call transmitters. The search for the distress caller always has to cover a large area.

The electronic distress call and position finding system consists of a receiver with a screen and a distress call transmitter. For evaluating the distress call, it requires the positions of both components.

These positions (A) of the receiver (1) and (B) of the distress call transmitter (2) are established by means of their GPS modules from the data of specialized satellites (4) which orbit earth on stationary orbits. The distress call transmitter radios its position (B) to the receiver. From the two positions, the distance and direction of the distress call transmitter are calculated.

If the system is used for diving, the switched-on receiver remains on the ship, and the distress call transmitters are secured to the diver so that they cannot get lost.

When a diver is drifting away, the distress call transmitter is switched on, the system begins to work, and his distance and direction with respect to the ship are displayed on the screen.

Then, the rescue of the diver is initiated in a well-aimed manner.

Simple distress call systems are based on optical and/or sound signals.

Essentially, these are:

life buoys in the form of inflatable balloons for persons floating on the water surface;

signal colors for intensely coloring the water surface;

signal distress rockets;

small flashlights (in darkness);

signal whistles.

These distress call systems are often insufficient since a great distance and unfavorable weather conditions (fog, thunderstorm, twilight, reflecting water, swell, storm etc.) make the locating of the distressed people impossible.

To date, electronic distress call systems have been employed, inter alia, for hospital and care applications, for persons buried alive by avalanches, and for aviation accidents.

In hospital and care applications, a distress call involves only the radio transmission of a personal characterization (name, room number etc.) to a control room. Thus, if the distress caller is outdoors, his position cannot be located.

The locating device for persons buried alive by avalanches works according to the method of approach to the trapped person, i.e., the area of the accident site must first be narrowed down to precisely locate the victim.

Distress call transmitters for accidents in aviation use the international aircraft distress call frequency. Its range is about 160 km in a flat terrain or on a calm sea, and the call can be received by an aircraft flying in a height of 6000 m.

The object of the invention stated in claim 1 has been to provide a distress call and position finding system which quickly and exactly determines the position of the distressed people, i.e., his distance and direction with respect to the receiver, in any weather and at a distance which exceeds visual and hearing distance.

This object is achieved by a system with the features stated in claim 1.

With the invention, it is achieved that distressed people can attract the attention of someone at their starting point, i.e., the location of the receiver, as soon as possible using the transmitter, without much active assistance, except for the switching on of the transmitter, so that their rescue can be initiated immediately thereafter.

One advantageous embodiment of the invention is stated in claim 3. The design of the electronic distress call and position finding system according to claim 3 allows its use also in places where no external power source is available (e.g., in an inflatable boat).

Another advantageous embodiment of the invention is stated in claim 4. The design of the electronic distress call and position finding system according to claim 4 allows its use for diving wherein the receiver remains at the starting point, and the distress call transmitters can be taken along by the divers during dive.

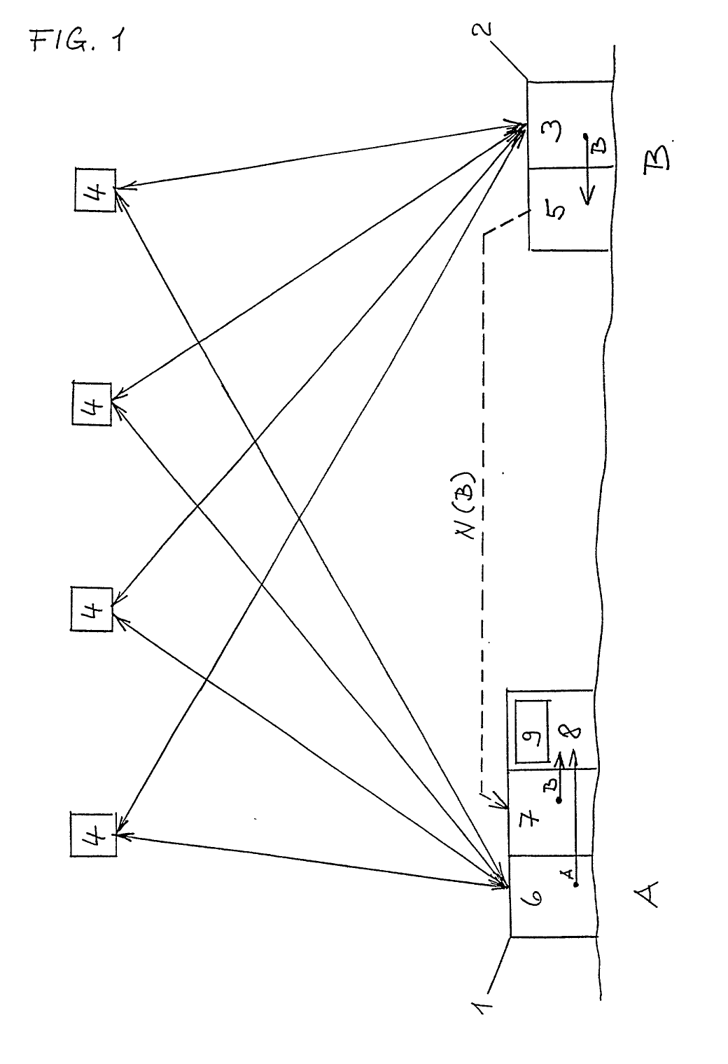

One Example of the invention is illustrated by reference to FIG. 1.

The electronic distress call and position finding system of FIG. 1 consists of a receiver (1) and one or, depending on the number of persons to be protected, more distress call transmitters (2).

The distress call transmitter consists of two components:

a GPS (global positioning system) module (3) which constantly determines its current position (B) using the data from existing specialized satellites (4) which orbit earth on stationary orbits;

a radio transmitter part (5) which transmits the current position (B) of the distress call transmitter as determined by the GPS module (3) as a distress call (N) on a carrier frequency to the receiver (1) for evaluation by the computer (8).

The receiver consists of three components:

a GPS module (6) which constantly determines its current position (A) using the data from existing specialized satellites (4) which orbit earth on stationary orbits;

a radio receiver (7) which receives the position (B) of the distress caller as a distress call (N);

a computer part (8) which calculates the direction and distance of the distress call transmitter (2) with respect to the receiver (1) from the two positions (A) and (B) and shows them on its display (9) in an easily understandable graphic form.

1. An electronic distress call and position finding system for rescueing distressed people, wherein said system consists of a receiver and at least one distress call transmitter and said receiver comprises a GPS (global positioning system) module for determining its own position and a radio receiver for receiving the distress calls, and said distress call transmitter includes a GPS (global positioning system) module for determining its own position and a transmitter which transmits this position to the receiver as a distress call on a carrier frequency, characterized in that said receiver comprises, in one housing, a computer having a display (screen) for evaluating and representing the data received from the GPS module and the radio receiver in addition to said GPS module and radio receiver, and said distress call transmitter is provided in the same housing as the GPS module and is equipped with a securing system for securing the transmitter to the person to be protected so that it cannot get lost and interference-free data radio transmission to the receiver is ensured without restricting the freedom of movement.

2. The electronic distress call system according to claim 1, characterized in that the computer of said receiver calculates the distance and direction of the distress call transmitter with respect to the receiver from its own determined position and the position transmitted from the distress call transmitter and represents them on the display.

3. The electronic distress call system according to claim 1 or 2, characterized in that the housing of said receiver is splashproof and suitable for portable and stationary use due to the fact that said receiver can be both operated with storage batteries and connected to external power sources.

4. The electronic distress call system according to any of claims 1 to 3, characterized in that the housing of said distress call transmitter is designed to be waterproof and pressure-tight up to 21 bar=down to 200 m depth of water and possesses an easy-change battery/easy-change storage battery with a charge control for power supply.
